(19) United States
(12) Patent Application Publication
(10) Pub. No.: US 2008/0092742 A1
(43) Pub. Date: Apr. 24, 2008

(54) Air Pollution Sensor System

(75) Inventor: Johan Marra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,294

(22) PCT Filed: Aug. 10, 2005
(86) PCT No.: PCT/IB05/52650

§ 371 Date: Feb. 6, 2007

(30) Foreign Application Priority Data
Aug. 11, 2004 (EP) 04300526.3

(51) Int. Cl. B60H 3/00; B03C 3/38

(52) U.S. Cl. 96/16; 96/26; 96/417

(57) ABSTRACT

The invention relates to an air pollution sensor system (1) incorporated in an enclosure (E), said enclosure comprising an air handling system inside an air duct (2), said air duct enabling a communication between air inside said enclosure and air outside said enclosure. The air duct comprises an air inlet for receiving air and an air outlet for releasing handled air inside said enclosure. The air pollution sensor system comprises at least one soot particle sensor (21) capable of sensing soot particles with a diameter in a range of approximately 5-500 nm inside said enclosure and providing a pollution information signal (P) in response to the sensing of said soot particles. The invention further relates to various types of soot particle sensors and air handling systems.

### FIELD OF THE INVENTION

The invention relates to an air pollution sensor system. The invention further relates to a sensor unit and an air handling system installable in such an air pollution sensor system.

### BACKGROUND OF THE INVENTION

During the past ten years, it has become increasingly clear that the inhalation of airborne combustion-related ultra fine particles (UFPs) presents a significant health-hazard to humans, owing to the fact that these particles tend to deposit on and eventually encapsulate in the lung tissue.

This applies in particular to those UFPs that comprise or largely consist of unburned elemental carbon. Such UFPs are commonly known as soot particles. Soot particles typically measure between 5 nm and 500 nm in diameter and are normally at least partially covered with carcinogenic polycyclic aromatic hydrocarbons (PAHs) and other volatile organic compounds (VOCs). They are emitted into air from the exhaust of combustion sources such as automobile motors and are formed as the result of an incomplete combustion process. In particular diesel motors are notorious for emitting large amounts of soot particles and other UFPs into air.

Apart from the neighborhood of industrial combustion sources and other stationary combustion sources, the concentration of combustion-related UFPs, hereafter simply referred to as soot particles, in the western world is generally highest on or near locations where motorized traffic is present. Very high local concentrations may be encountered particularly in tunnels, traffic intersections and/or in traffic queues under conditions of limited ventilation and/or windspeed. However also in (rooms of) buildings, recreational cabins, huts, homes, vessels, aircraft, spacecraft, and individual compartments/rooms inside said vehicle cabins, recreational cabins, huts, homes, buildings, vessels, aircraft, and spacecraft, highly health-hazardous concentrations of soot particles may be encountered.

Especially automobile drivers and passengers become readily exposed to elevated concentrations of soot particles and other exhaust pollutants because the vehicle's air handling system (which may e.g. be either a heating, ventilating, air conditioning system or a basic heating/ventilation system) continuously draws outside air, that is polluted by the exhaust gases and particles emitted from the exhausts of other vehicles, into the vehicle cabin. It is therefore desirable to be able to at least partly clean the outside air of various airborne pollutants by means of an air cleaning unit before allowing its entrance into the cabin, and to automatically control the settings of the vehicle's air handling system in response to conditions pertaining to the outside air, notably the humidity, the temperature and the pollution level, in order to minimize the exposure of the vehicle's inhabitants to air pollutants, while retaining comfortable temperature and humidity levels.

As described in U.S. Pat. No. 5,775,415, the operation mode of the vehicle's air handling system can be controlled by an electrical control unit that actuates and controls the rotation of a switching damper element, positioned between the cabin air inlet and the outside air inlet associated with the air handling system. The switching damper element is rotated such as to fully close the cabin air inlet and to fully open the outside air inlet in the input mode operation, while fully opening the cabin air inlet and fully closing the outside air inlet in the re-circulation mode operation. In the mixed mode operation, the switching damper element can assume a series of intermediate positions that partly open both the cabin air inlet and the outside air inlet such that a controlled amount of re-circulating cabin air and a controlled amount of outside air are simultaneously allowed to enter the air handling system.

### SUMMARY OF THE INVENTION

It is an object of the invention to provide an air pollution sensor system for an enclosure containing an air handling system, wherein said air pollution sensor system is apt to provide information on the pollution of the air within said enclosure with respect to soot particles.

To this end, an air pollution sensor system is provided as defined in claim 1.

The application of a soot particle sensor in the air pollution sensor system generates specific information on the pollution by soot particles or soot-like particles, such as smoke particles, within the enclosure. Since the inhalation of airborne soot particles is known to be far more hazardous to human health than the inhalation of common exhaust gases, it is important to recognize the airborne soot particle concentration as an important contributor to the air pollution level. In this regard, the air pollution sensor system comprises a soot particle sensor while the air handling system may have characteristics that make it particularly suitable for the removal of soot particles and soot-like particles from air prior to its release inside the enclosure.

The embodiment of the invention as defined in claim 2 provides the advantage that the performance of the air cleaning unit with respect to soot particles can be evaluated. The difference between e.g. the air pollution level inside the enclosure and the outside air pollution level is often directly determined by the efficiency of an air cleaning unit of an air handling system, at least in case no pollution sources are present within the enclosure.

The embodiment of the invention as defined in claim 3 provides the advantage that the contribution of pollution sources of soot particles and soot-like particles not entering the enclosure via the air duct can be taken into account. Examples include the presence of combustion-type pollution sources inside the enclosure, such as inhabitants smoking a cigarette, incense burning, soot particles entering the enclosure via an open window, the presence of an open fire place, and the presence of a non-electric cooking stove.

The embodiment of the invention as defined in claim 4 provides the advantage that both the concentration of soot particles entering the enclosure via the air duct and the concentration of soot particles present within the enclosure away from the air duct can be detected independently from each other, and information can be provided with respect to both the soot particle concentration in the air entering the enclosure via the air duct and the soot particle concentration in the air inside the enclosure away from the air duct that is actually inhaled by people residing in the enclosure. This embodiment is particularly useful to unambiguously detect the presence of air pollution sources inside the enclosure.

The embodiment of the invention as defined in claim 5 provides the advantage of enabling an automatic variation in the operation of the air cleaning unit as a function of the sensed soot particles, e.g. the concentration(s) of soot particles. If the pollution level within the enclosure and/or downstream of said air cleaning unit increases e.g. above a certain threshold, the pollution information signal may control the air cleaning unit to improve its cleaning operation with respect to soot particles such that the soot particle concentration in the air inhaled by people inside the enclosure returns to an acceptable value.

The embodiment of the invention as defined in claim 6 provides the advantage of controlling the air flow through the air duct. The air cleaning efficiency may depend on the amount of air that is displaced by the air handling system per unit of time because this determines the air speed through the air cleaning unit.

The embodiment of the invention as defined in claim 7 provides the advantage that charging of airborne soot particles has been found to be an effective means for allowing the accomplishment of a significant increase in the soot particle filtration efficiency of a filtering section that is positioned downstream of the soot particle charging section.

It should be acknowledged that the embodiments described above, or aspects thereof, may be combined.

It is a further object of the invention to provide a sensor unit for adequately sensing soot particles.

To this end, a sensor unit is proposed for the sensing of airborne soot particles as defined in claim 8.

It has been found that the occurrence of a net electrical charge (positive) on airborne soot particles allows an adequate and reliable sensing of these soot particles. Irradiation with ultraviolet light has been found to be a very effective means for the charging of soot particles and soot-like particles through the mechanism of photo-electric charging for the purpose of sensing and/or denuding a flow of air from these soot particles.

In a preferred embodiment of the invention, the soot particle precipitation section comprises two electrode surfaces between which a high electric field can be established. It has been found that such a precipitation section allows for adequate and reliable sensing of soot particles. The embodiments of the invention as defined in claim 9 provide the advantage that parallel plates incur only a negligible air pressure drop across the soot particle precipitation section when air is passed through the flow conduit within this section.

The embodiment of the invention as defined in claim 10 comprises another suitable means for sensing soot particles. The advantage of using a fibrous dust filter inside a Faraday cage (that is connected via a sensitive current meter to earth potential) for capturing charged soot particles from the air passing though the sensor unit lies in the circumstance that no voltage differences need to be applied to the precipitation section which avoids the existence or voltage-induced capacitive currents, thus making the accurate measurement of small electric currents arising from the deposition of charged airborne soot particles inside the Faraday cage associated with the precipitation section much easier to accomplish.

The embodiment of the invention as defined in claim 11 provides the advantage that the heat developed by the ultraviolet light source can be used for inducing a thermal chimney effect that draws a controlled airflow vertically through the soot sensor. For the chimney effect to be effective, the sensor unit is preferably positioned vertically and the precipitation section is positioned substantially above the illumination section. The developed heat from the lamp inside the sensor is also advantageous for desorbing moisture from the soot particles which could otherwise quench the photoemission process. Finally, the chimney effect is advantageous from a cost point of view as it avoids the required presence of a pump or fan to draw air through the soot sensor.

It is a still further object of the invention to provide an air handling unit capable of removing airborne UFPs from an air flow.

To this end, an air handling system is provided as defined in claim 12.

It has been found that a charging of soot particles provides for a very effective means for facilitating and improving the removal of at least a part of the soot particles from an air flow.

The embodiment of the invention as defined in claim 13 provides the advantage of an effective means for charging soot particles in order to remove these particles in the filtering section. The embodiment of the invention defined in claim 14 is effective in charging different types of UFPs.

The embodiment of the invention as defined in claim 15 provides the advantage that ozone gas, generated from e.g. a quartz ultraviolet lamp, is prevented from leaving the sensor unit.

The embodiments of the invention as defined in claims 16-20 provide controllable filtering sections capable of effectively removing soot particles from air.

It should be acknowledged that the embodiments described above, or aspects thereof, may be combined.

The invention will be further illustrated with reference to the attached drawings, which schematically show preferred embodiments according to the invention. It will be understood that the invention is not in any way restricted to these specific and preferred embodiments.

### BRIEF DESCRIPTION OF THE DRAWINGS

In the drawings:

FIGS. 1-5 show schematic diagrams of an air pollution sensor system in an enclosure comprising an air handling system inside an air duct, according to embodiments of the invention;

FIGS. 6-10 show schematic illustrations of soot particle sensor units, according to embodiments of the invention, and

FIGS. 11 - 15 show schematic illustrations of air handling systems, in particular air cleaning units, according to embodiments of the invention.

### DETAILED DESCRIPTION OF THE DRAWINGS

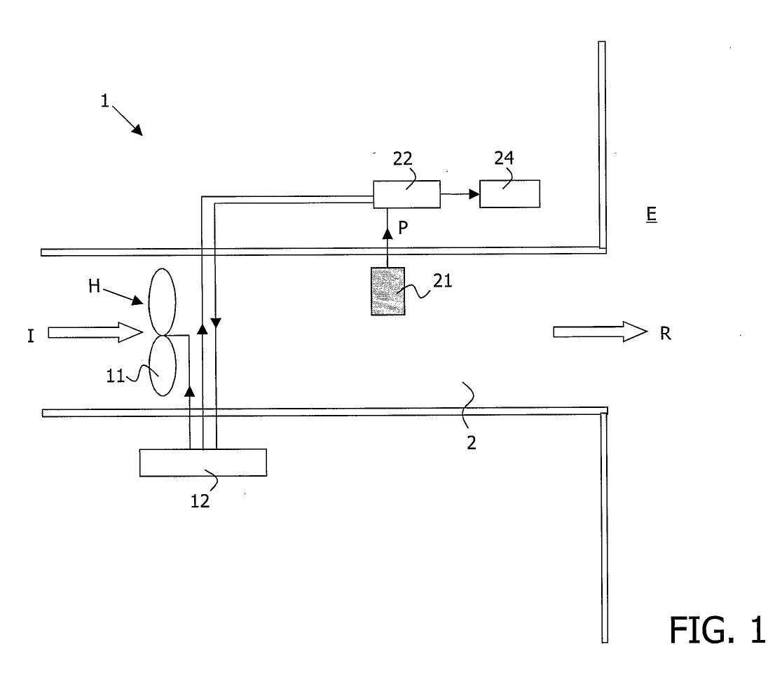

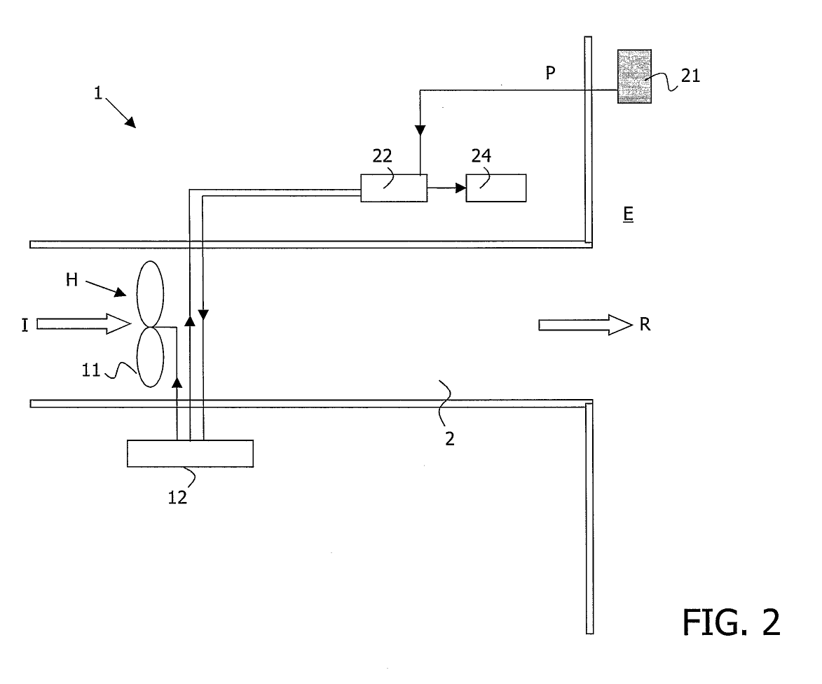

The present invention discloses an air pollution sensor system 1, shown in FIGS. 1-5, incorporated in an enclosure E. The enclosure E comprises an air handling system H inside an air duct 2, said air duct 2 enabling a communication between air inside said enclosure E and air outside said enclosure E. The air duct 2 comprises an air inlet for receiving air I and an air outlet for releasing handled air R inside said enclosure E.

The enclosure E may be any kind of residence/dwelling, including vehicle cabins, recreational cabins, huts, homes, buildings, vessels, aircraft, spacecraft, and individual compartments or rooms inside said vehicle cabins, recreational cabins, huts, homes, buildings, vessels, aircraft and spacecraft. Hereinafter only the specific example of a vehicle cabin enclosure will be described in more detail but it should be noted that an entirely analogous description applies to all other mentioned enclosures. Furthermore, it should be noted that the air handling system H may or may not comprise heating and/or cooling means. A mentioning of the air handling system being embodied as a HVAC system (thus formally comprising heating and cooling means) does not exclude the air handling system to be embodied as an ordinary air handling system without heating and/or cooling means. The term “HVAC” does not imply a requirement for the presence of means for air heating and/or air cooling. The terms “soot” or “soot particle(s)” should be understood to also comprise soot-like particles such as the smoke particles that are produced by some combustion process.

The air handling system H may e.g. comprise a HVAC ventilator 11 for displacing air through said air duct 2 and/or an air cleaning unit 13 for cleaning air passing said air cleaning unit 13. The air pollution sensor system may comprise control electronics including e.g. a HVAC controller unit 12 and an air cleaning controller unit 14. The HVAC controller unit 12 tunes the ventilation speed and selects the mode of HVAC operation comprising normal inlet-mode operation, re-circulation mode operation or mixed-mode operation.

At least one soot particle sensor 21 is provided capable of sensing soot particles with a diameter in a range of approximately 5-500 nm. Upon sensing soot particles, the sensor 21 provides a pollution information signal P.

Evaluation of output signals from the air cleaning unit 13 and/or the sensor 21 is respectively performed by an air cleaning evaluation unit 23 and an air pollution evaluation unit 22. An air pollution indication unit 24 is preferably present to provide pollution information to inhabitants of the enclosure E.

FIG. 1 shows an embodiment comprising a single soot sensor 21 without an air cleaning unit inside a vehicle's HVAC system. A coarse pre-filter (not shown) upstream of the ventilator 11 may be present to remove large debris from air. The soot particle air pollution information signal P obtained from the sensor 21 is evaluated by an air pollution evaluation unit 22 and visualized on an air pollution indicator/warning unit 24.

In inlet mode operation, only the soot particle pollution in the outside air is recorded and it is this pollution that also enters the vehicle cabin E. During normal inlet mode operation, it is not possible to detect smoking activities or a presence of open cabin windows (it is of course possible to detect open windows electronically). In case the measured soot particle pollution level entering the cabin exceeds a given threshold, the air pollution evaluation unit 22 will trigger the HVAC controller 12 to switch from normal inlet mode operation to re-circulation mode operation in order to avoid continued passage of large amounts of pollutants into the cabin E. Re-circulation gradually leads to a reduction of the soot particle concentration because of particle deposition on the various walls inside the air duct 2 and the cabin interior E. Re-circulation will only continue for a limited period of time (in order to keep the carbon dioxide and/or moisture concentration inside the cabin within safe and comfortable limits) after which outside air I is again allowed to pass into the vehicle cabin E for at least a minimum period of time by switching the air handling system H back to inlet mode operation. Thereafter the air handling system may again be switched into re- circulation mode operation in case the soot particle pollution in the outside air is still too high.

In case of normal inlet-mode operation, it is not possible to detect smoking or intrusion of soot-like pollutants through open windows in the embodiment of FIG. 1. Of course, a presence of open windows can be electronically detected and such information may always be relayed as a warning to the vehicle inhabitants, in particular when the outside air pollution has become sufficiently high to have triggered a change from inlet-mode operation to re-circulation mode operation. In case of re-circulation mode operation and closed windows, smoking activity is detected when the recorded particle pollution increases in the course of time because cabin air re-circulation brings the smoke particles in contact with the sensor 21 (also tobacco smoke particles can be charged through photo-electric charging following illumination with UV-light of a sufficiently short wavelength, albeit to a lesser extent than pure soot particles). This may then be indicated as a warning signal on the air pollution indicator/warning unit 24 to the vehicle inhabitants that smoking has been detected and that the encountered air pollution endangers human health. At the same time, detection of smoking triggers a return to inlet-mode operation while increasing the ventilation speed through the cabin, for at least a minimum set period of time, in order to remove the smoke particles from the cabin E as quickly as possible. After that period of time, it is sensed whether the sensed soot particle pollution level (in the outdoor air) is still at such a high level as to trigger again at least a temporary switch to re-circulation-mode operation and the described sequence of events may be repeated. In the embodiment of FIG. 1, only a limited degree of personal protection against exposure to particle pollutants from the outside air is accomplished.

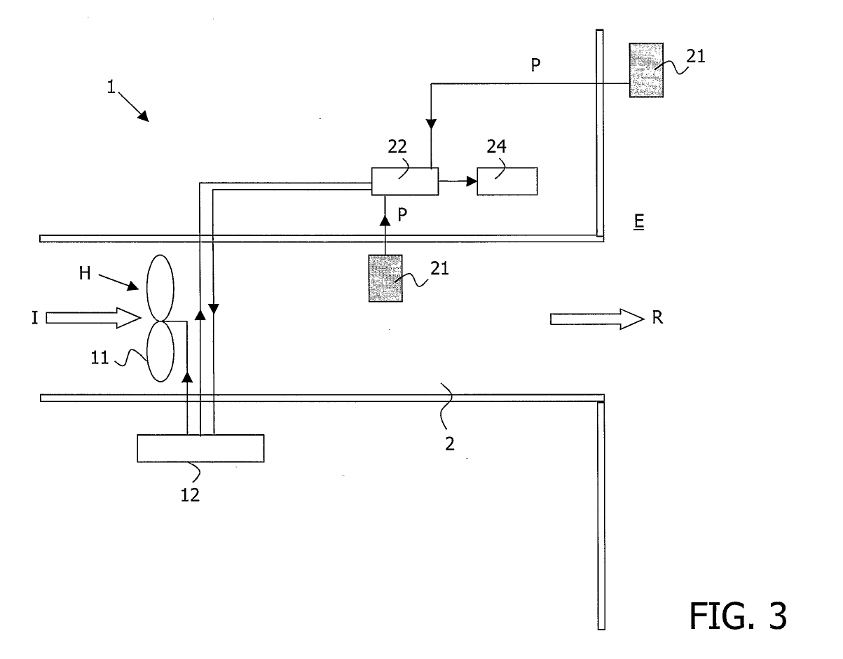

FIG. 2 shows an embodiment with the particle sensor 21 in the cabin E instead of in the air duct 2. No air cleaning unit is present. In contrast with the embodiment of FIG. 1, the soot particle pollution level is now directly sensed in the air of the cabin E, which air is inhaled by the inhabitants. During normal inlet mode operation, it is not possible to detect the presence of soot or soot-like particles inside the cabin that are specifically introduced from smoking and/or open windows, only the actual soot particle pollution level in the cabin E is recorded and this may be made visible on an air pollution indicator unit 24. In case the, recorded soot particle pollution exceeds a set threshold soot pollution level, a trigger signal is send to the controller unit 12 to switch to re-circulation mode operation for at the most a set maximum period of time. In case of closed windows and an absence of smoking, this measure will slowly decrease the recorded soot particle pollution level. When the recorded soot particle pollution level has fallen below a second set pollution level, the system is switched back to normal inlet mode operation. Alternatively, a switch back to inlet mode operation for at least a set minimum period of time is made after the first set maximum period of time has passed during which re-circulation mode operation has existed. In case of smoking activity inside the cabin, the recorded soot-like pollution level will not significantly decrease during re-circulation mode operation and, when this is recorded during a set period of re-circulation time, this triggers a switch back to inlet mode operation for at least a set minimum period of time at a preferably higher ventilation speed in order to remove the smoke from the cabin. It should be noted that tobacco smoking inside the cabin will generally lead to a higher soot-like particle pollution level inside the vehicle cabin than the soot particle pollution level existing outside the vehicle. A recorded smoking activity can be relayed as a warning message to the air pollution indicator unit 24 together will the actually recorded soot particle pollution level to which the vehicle inhabitants are exposed and the relative danger to human health of that recorded particle pollution level.

Also this embodiment is effective with regard to safeguarding human health for exposure to particulate pollutants, but the effectiveness remains limited and is at its best when no smoking activity occurs and when the windows are closed. Smoking activity can be more readily detected than in the embodiment of FIG. 1, but still can only unambiguously be recorded during re-circulation mode operation under conditions wherein knowledge about the presence of open windows is obtained from other electronic sensing means.

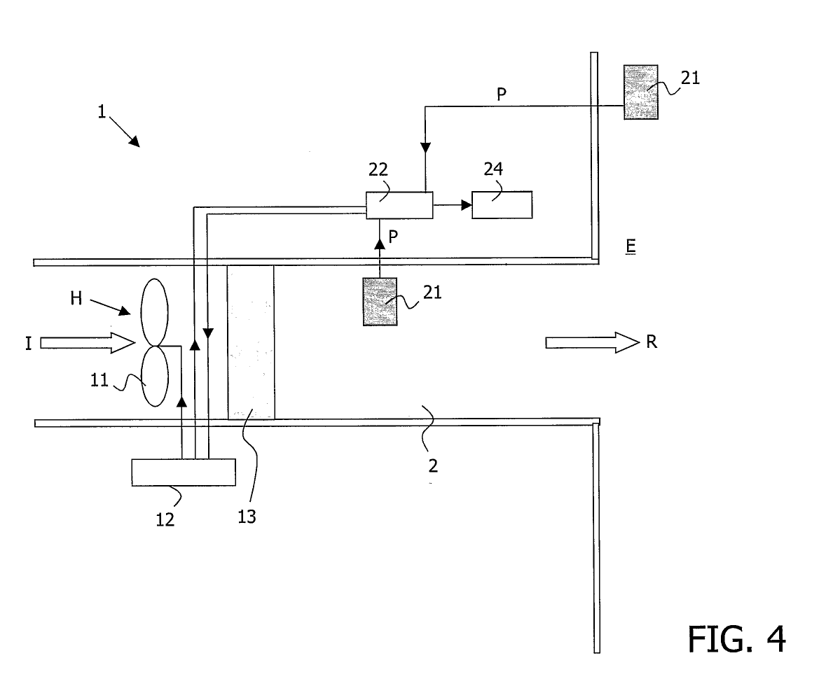

FIG. 3 shows a more preferred embodiment with soot particle sensors 21 in both the air duct 2 and in the cabin E. The electronic output pollution information signal P from both soot sensors 21 is send to an air pollution evaluation/comparator unit 22 wherein both signals are compared with each other and from where appropriate electronic feedback signals may be send to the HVAC controller unit 12 and electronic information signals to the air pollution indicator unit 24. In case no smoking occurs, both sensors 21 readings are substantially the same in any mode of HVAC operation and are independent of whether the cabin windows are open of closed. However, whether windows are open or closed can affect the recorded air pollution levels during re-circulation mode operation. Also here, a presence of open windows is best sensed by independent electronic means and relayed as a warning message to the vehicle inhabitants. During normal inlet mode operation, a smoking activity will betray itself through a measurement by the sensor 21 in the cabin E that is (substantially) higher than the measurement by the sensor 21 in the air duct 2. This can be relayed as a warning to the air pollution indicator unit 24. Normal inlet mode operation may be maintained as long as the cabin sensor reading is higher than the sensor reading within the air duct 2, irrespective of the actually recorded outdoor soot-like particle pollution level by the sensor 21 within the air duct 2. A switch to re-circulation mode operation will only occur when no smoking activity occurs (both readings of sensors 21 are the same) and when the recorded soot pollution level by the sensor 21 in the air duct 2 exceeds a certain set pollution level. Re-circulation then proceeds for at the most a set maximum period of time or until the reading of the sensor 21 has dropped below a set pollution level after which normal inlet mode operation is again chosen for at least a set minimum period of time. It is noted that also re-circulation mode operation may still allow for the introduction of a (very) limited amount of outside air into the vehicle cabin via the duct 2.

The embodiment of FIG. 3 provides an improved embodiment to protect human health primarily because of its extended sensing capability as compared to the embodiments shown in FIGS. 1 and 2 with respect to tobacco smoking or other activities that involve some form of combustion and/or smoke production.

The embodiment shown in FIG. 4 is similar to those shown in FIGS. 1-3, respectively, apart from a passive air cleaning unit 13. The air cleaning unit may comprise e.g. a fibrous (electret) filter and possibly additional filtration means for the removal of polluting gases from the air. The presence of the air cleaning unit 13 allows a quicker reduction of the overall particle pollution level, including the soot particle pollution level, during re-circulation mode operation described with reference to FIGS. 1-3.

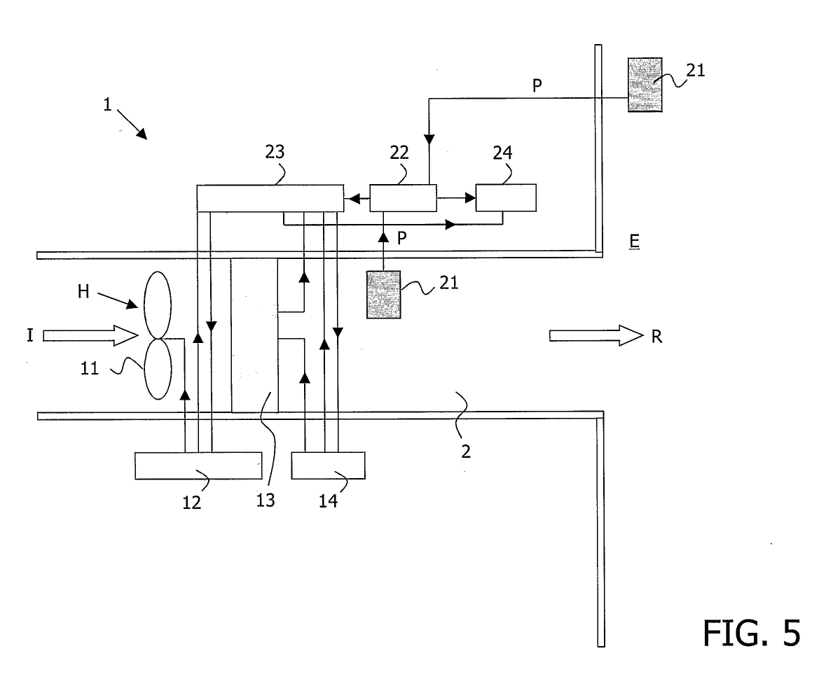

The embodiment of the invention shown in FIG. 5 is a more preferred embodiment because also an air cleaning unit 13 comprising an electrostatically augmented particle filter together with a particle charging section is provided. Electrostatically- augmented particle filters have the general characteristic that their particle filtration efficiency is augmented through the presence of a deliberately applied electric field within the filtration regions where the actual particle removal from air occurs. This deliberately applied electric field may also lead to field-induced leakage currents inside the filter and, in order to at least partly counteract such leakage currents, it is common practice to avoid the presence of conducting materials at locations wherein (physical) connections must be made between materials that are set to have different electric potentials with respect to each other. Electronic feedback signals may be relayed from the air pollution evaluation unit 22 to the air cleaning controller 14 and it may be sensed whether the end of filter lifetime has been reached by e.g. recording the overall leakage current occurring inside the electrostatically augmented particle filter while taking account of the relative humidity of the air passing through the air cleaning unit. Also end-of-filter lifetime information can be relayed as a message to the vehicle inhabitants. Air cleaning occurs to a significant extent inside the air cleaning unit 13 and normal inlet mode operation can be maintained for most of time thus allowing a more healthy air quality.

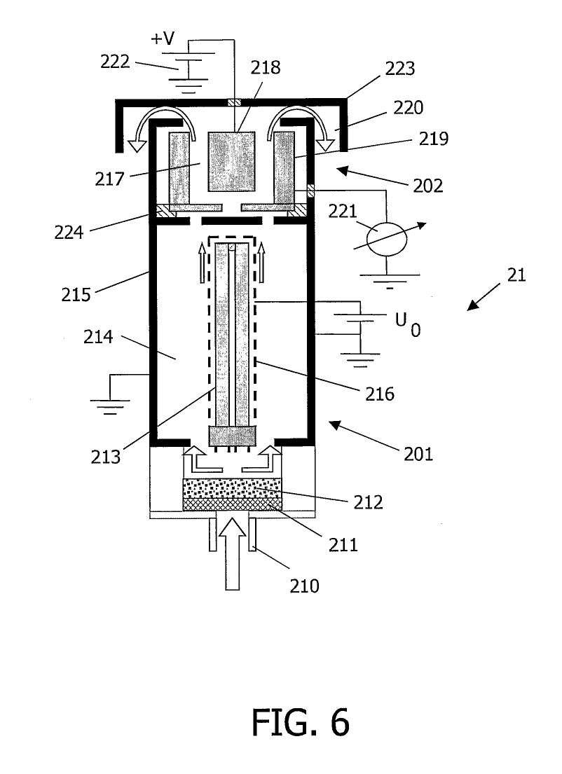

FIGS. 6-10 show schematic illustrations of soot particle sensor units 21, according to embodiments of the invention. The design rules of soot particle sensors for general-purpose soot measurements in air are known from prior art (see U.S. Pat. Nos. 4,574,004, 4,837,440, 5,431,714, which may be considered as incorporated to the present patent application as known documents). It is advantageous to specifically tailor these design rules for the present application.

According to one preferred embodiment, this soot particle sensor 21 comprises, as described below in more detail with reference to FIGS. 6 to 10, an inlet section, which is optionally provided with a coarse particle pre-filter 211 serving to remove relatively large airborne particles possessing a diameter larger than about 1 μm from the input influx airflow passing through said inlet section, an illumination section 201, mainly comprising an ultraviolet (UV) light source 213, the radiation emitted therefrom serving to induce a photoelectric charging of airborne soot particles in the air moving through the soot sensor, and a particle precipitation section 202, wherein the charged soot particles are either electrostatically precipitated onto an electrode surface that is connected via a sensitive current meter to earth potential or wherein the charged soot particles are filtered out of the air by means of a filtration unit enclosed within a so-called electrically conductive Faraday cage that is connected via a sensitive current meter to earth potential (in each case giving rise to an electrical current with a magnitude that is proportional to the amount of airborne charged soot particles).

More precisely, in the present implementation of the invention, for soot sensing in automobile cabin air, a soot particle sensor unit 21 such as depicted in FIG. 6 is advantageously used. Said sensor 21 includes an inlet section, an illumination section, and a particle precipitation section.

The inlet section preferably comprises an inlet port 210, intended to receive a cold influx airflow with charged and uncharged particles, the inlet port preferably comprising a coarse particle pre-filter 211 and, optionally, an electrostatic aerosol filter 212 for capturing charged particles and ions from the influx airflow. The pre-filter 211 enables the mechanical removal of at least part of the large airborne dust particles, possessing a diameter larger than approximately 1 μm, from the influx airflow before being able to enter the illuminating section, thereby prohibiting a quick soiling of the interior of the soot sensor 21 by particle deposits (the said large airborne dust particles usually comprise most of the airborne particle mass). Soot particles are generally much smaller than said large airborne dust particles and are therefore not substantially removed from the air entering the illumination section by said coarse particle pre-filter.

The illumination section 201 comprises a UV lamp 213, e.g. a tubular low-pressure UV lamp emitting radiation that comprises a wavelength below 260 nm. Ordinary low-pressure UV lamps, such as those commonly used for disinfection purposes, are provided with a gas filling comprising mercury vapor. These UV lamps emit a peak wavelength of 253.7 nm and, in case the UV lamp is embodied as a (synthetic) quartz lamp, an additional peak wavelength of 184.9 nm. Alternatively, the UV lamp may be a UV-excimer lamp, the radiation wavelength of which can be tuned between 170 nm and 260 nm, dependent on the nature and composition of the filling gas inside the excimer lamp.

The illumination section 201 further comprises a flow conduit 214 between the UV lamp 213 and the inner (reflective) wall of an external housing 215 of the sensor housing where through the airflow occurs. Soot particles that are at least partly covered with a coating of PAH material, which is normally the case for all soot particles, will undergo photoemission of one or more electrons when they are irradiated with UV light possessing wavelength peaks below 260 nm, which makes these particles to become positively charged. By disposing a protective conducting gauze 216 of high porosity around the UV lamp 213, the lamp is shielded from direct exposure to the airflow through the soot sensor, thereby avoiding a gradual contamination of the lamp surfaces through depositing UFP's from air, which would otherwise reduce the light output from the lamp in the course of time.

In addition, it is advantageous to impose a small DC or AC voltage of U₀=about 5-10 V on this gauze 216 and to earth the inner conducting wall of the sensor housing 215 so that a small electrostatic field exists across the flow conduit 214. This electric field promotes the rapid removal of photo-emitted electrons and negative ions from the air while hardly affecting the transit of the positively charged soot particles through the flow conduit 214 (because of the much higher electrophoretic mobility of electrons and ions). The charged (and remaining uncharged) soot particles subsequently enter the precipitation section 202 of the sensor 21.

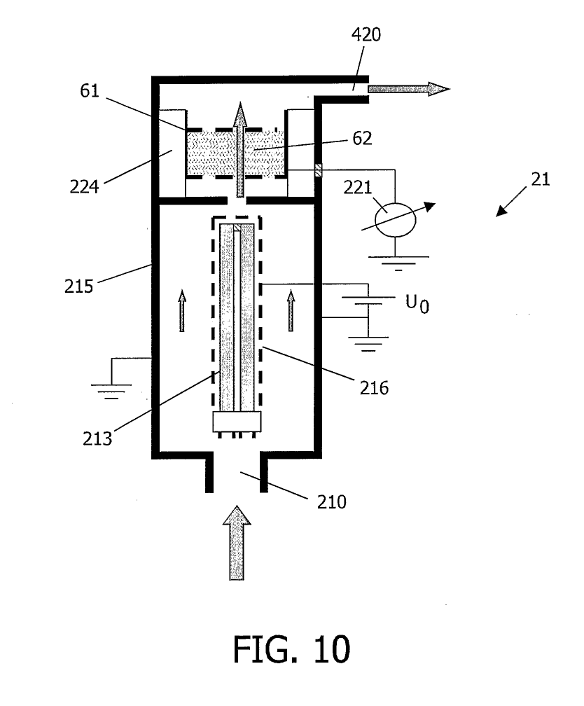

The particle precipitation section 202 comprises a second flow conduit 217 which is either present (FIGS. 6 to 9) between two parallel electrode surfaces 218 and 219 (between which a high-voltage supply 222 connected to the inner electrode 218 creates a high electric field that causes at least part of all charged soot particles to deposit on the electrode 219 that is connected via a sensitive current meter 221 to earth potential) or which passes (FIG. 10) through a fibrous dust filter 62 located within a so-called Faraday cage 61 causing at least part of all charged soot particles to deposit on the fibers of the dust filter inside the said Faraday cage, the said Faraday cage being connected via a sensitive current meter to earth potential. In all cases, the deposited charge per unit time is measured as an electric current through the said current meter 221. The measured current is proportional to the amount of airborne charged soot particles via a calibration factor. With respect to the sensor housing 215, the electrode 219 is electrically isolated by means of insulation elements 224.

The airflow through the soot sensor 21 will normally be limited to no more than a few liters/minute and can be established by a ventilator or a pump (not shown), which is preferably connected to an air exit 220 of the soot sensor, this exit being located under a covering cap 223 and receiving the lamp-heated exiting air. For the present application, it is advantageous to use the developed heat from the UV lamp 213 for inducing a thermal chimney effect that draws a controlled airflow vertically through the soot sensor 21. The airflow can then be additionally regulated by means of one or more air flow obstructions (not shown) inside the sensor that induce a finite pressure drop (e.g. obstructions in the various flow conduits or through the pressure drop incurred by the fibrous dust filter 62 in the Faraday-cage 61 and/or through the pressure drop incurred by the coarse pre-filter 211 and/or by the electrostatic aerosol filter 212 in the inlet section of the soot sensor).

For the chimney effect to be effective, the sensor 21 is preferably positioned vertically and the precipitation section 202 is positioned above the illumination section 201. The developed heat from the UV lamp 213 inside the sensor 21 is also advantageous for desorbing moisture from the soot particles which could otherwise quench the photoemission process. Finally, the chimney effect is advantageous from a cost point of view as it avoids the required presence of a pump or fan to draw air through the soot sensor. It is important to note that the total airflow through the integrated air cleaning unit located upstream of the soot sensor can amount up to 10 m³/min and is thus many orders of magnitude higher than the airflow through the soot sensor unit.

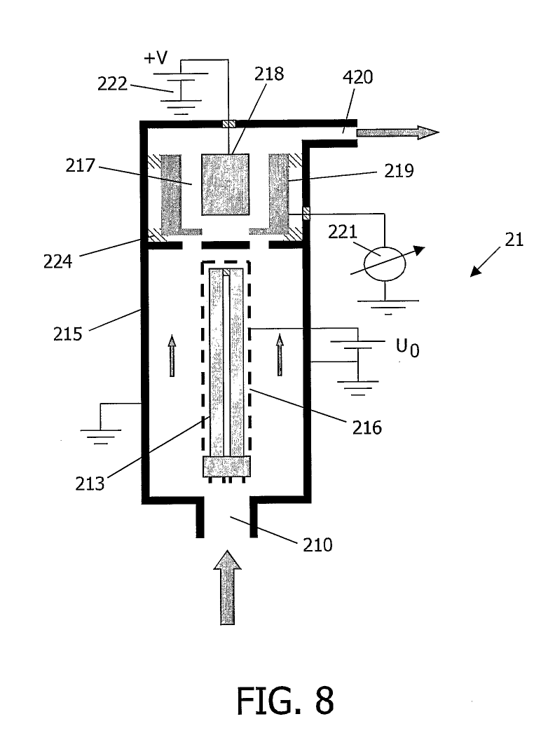

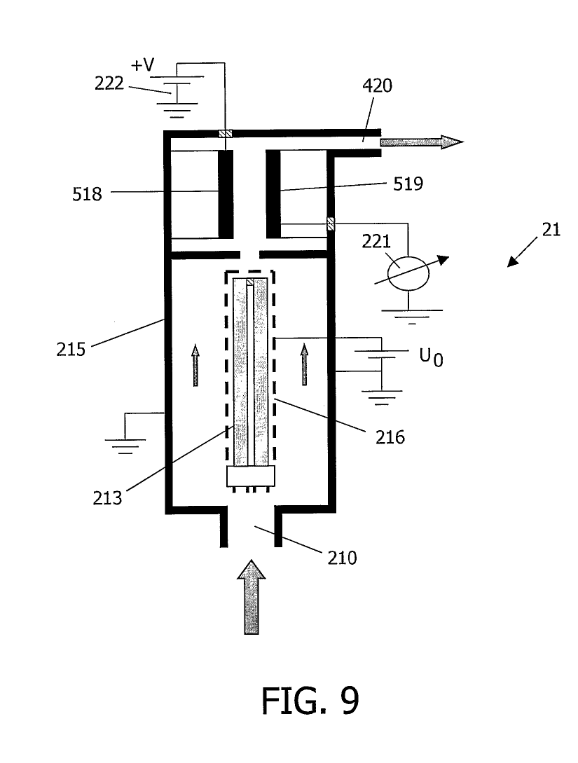

The soot sensors 21 of FIGS. 6-10 illustrate either a cylindrical-concentric charged-particle precipitator with a modified shape of air exit (FIG. 8), a parallel-plate charged-particle precipitator with said modified air exit (FIG. 9), or a Faraday-cage type of particle filter (FIG. 10).

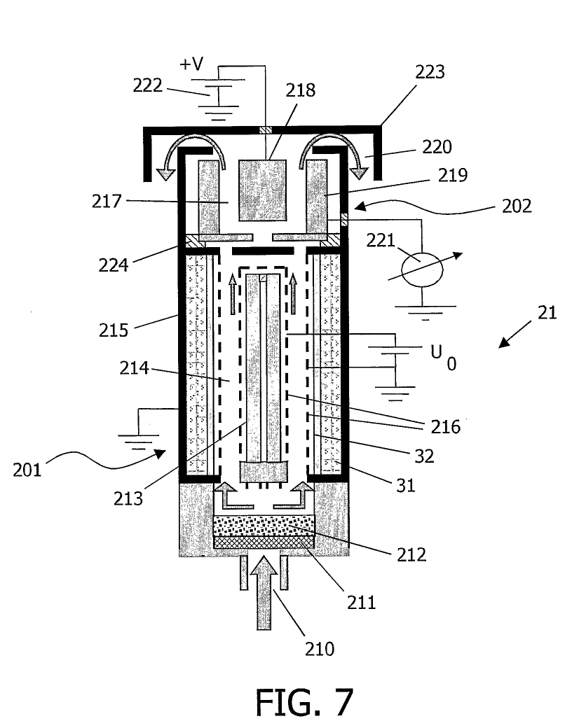

An advantageous embodiment of the soot particle sensor is depicted in FIG. 7 wherein an additional white diffuse-reflective material, e.g. a layer of UV-reflective white powder 31 or a pigment/binder coating layer comprising Al₂O₃, MgO, SiO₂, Ca-pyrophosphate or BaSO₄ powder/pigment particles, has been disposed between the inner conducting wall of the sensor housing 215 and a UV-transparent glass or quartz window 32 facing the UV lamp 213. This reduces the absorption of UV light and thus enhances the reflection of UV light, thus establishing a higher UV intensity inside the flow conduit 214 and therefore a more efficient photoemission process, which, in turn, allows for a faster airflow through the sensor and thus a faster sensor response time. A protective electrically conductive gauze 216 of high porosity is also provided on the side of the UV-transparent window 32 facing the UV lamp 213 for the purpose of shielding the UV-transparent window 32 from direct exposure to the airflow passing through the flow conduit in the illumination section of the sensor, thereby avoiding or at least retarding the gradual deposition of airborne contaminants on the window 32. Preferably, a small DC or AC voltage difference U₀ of about 5-10 V is set up between the gauze 216 provided around the UV-lamp and the gauze provided on the UV-transparent window 32 so that a small electrostatic field exists across the flow conduit in the illumination section of the sensor. This electric field allows the rapid removal of photo-emitted electrons and negative ions from the air while hardly affecting the transit of the positively charged soot particles through the flow conduit (because of the much higher electrophoretic mobility of electrons and ions).

The surfaces of the gauze 216 in FIGS. 6 to 10 are preferably covered with a thin coating of a non-metallic material, said coating being sufficiently thick to quench the photo-emission of electrons from the said surfaces of the gauze 216 when the said surfaces are illuminated with UV light emitted from the said UV lamp 213, the said coating being sufficiently thin to guarantee a finite electrical conductivity across the said coating. A quenching of the photo-emission of electrons from the surfaces of the gauze 216 is desirable because such emitted electrons are capable of neutralizing at least some photo-charged airborne soot particles which would reduce the overall charging efficiency of the soot particles during their passage through the flow conduit 214.

For the same reason, also other metallic surfaces facing the UV lamp 213 are preferably covered with a thin coating of a non-metallic material to prevent the photo-emission of electrons when said other metallic surfaces are exposed to irradiation with UV light.

FIG. 8 illustrates an embodiment in which the soot sensor 21 is equipped, in the precipitation section 202, with a cylindrical-concentric charged-particle precipitator 217, 218, 219 identical to that shown in FIGS. 6 and 7, but with an air exit 420 which, under the cap of the soot sensor 21, has a different shape. FIG. 9 illustrates another embodiment 517, 518, 519 which is similar to the one illustrated in FIG. 7, but in which the precipitation section 202 now includes, around a flow conduit 517, a parallel-plate charged-particle precipitator with two electrodes 518, 519. FIG. 10 shows an embodiment in which the precipitation section 202 includes a Faraday cage 61 and a porous particle filter 62 inside said Faraday cage.

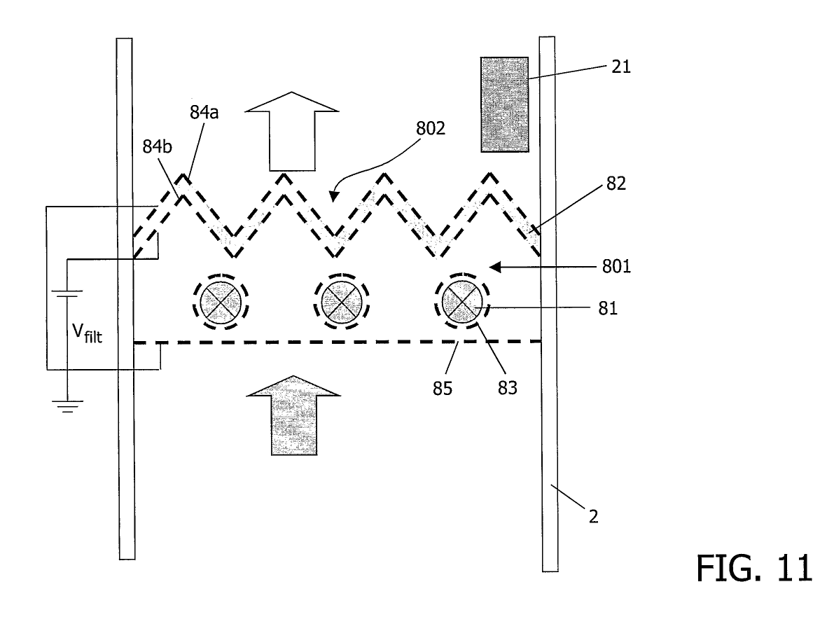

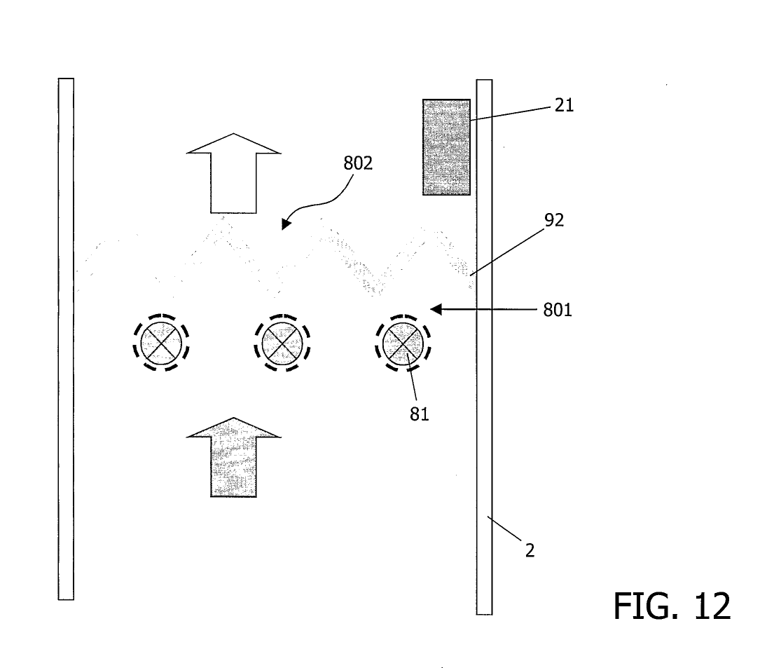

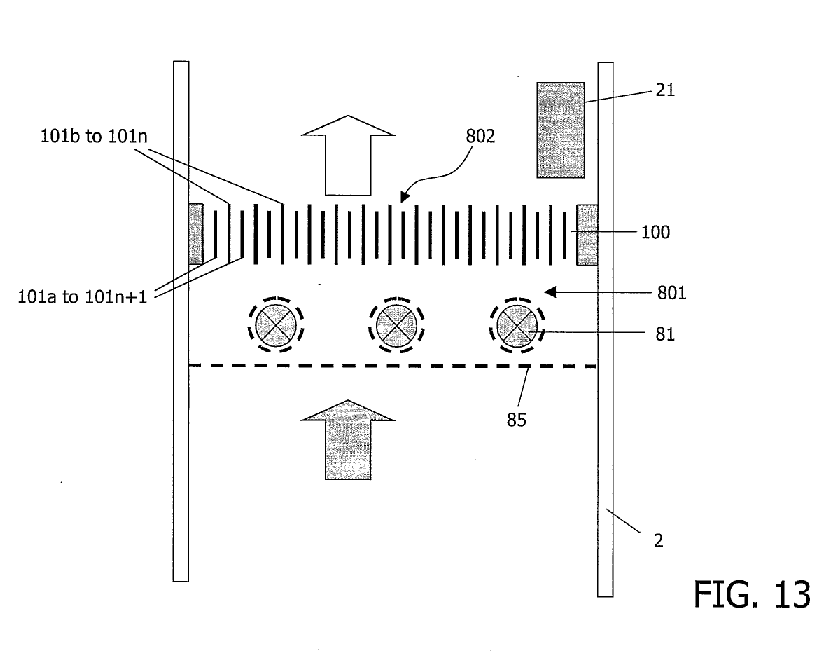

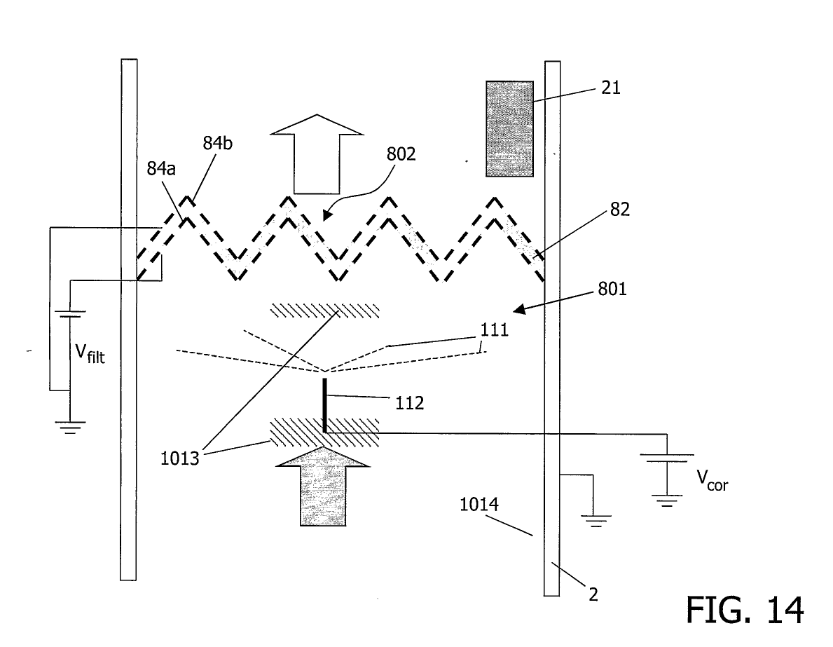

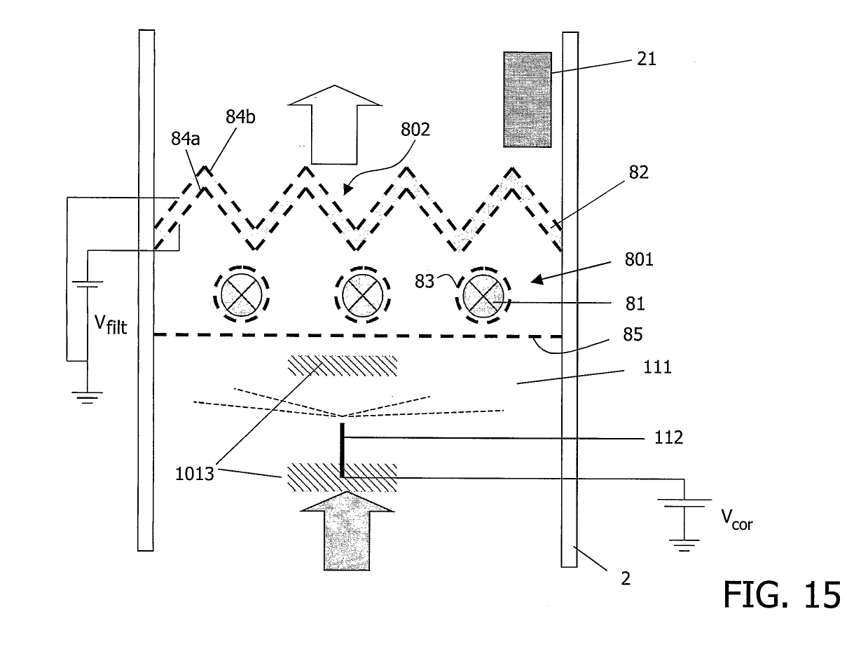

The air handling system or air cleaning sub-system, also described later in greater detail with reference to FIGS. 11 to 15, comprises a particle charging section 801, for the electrostatic charging of airborne particles, in particular of airborne soot particles, in the airstream moved by the vehicle's air handling system, and a filtering section 802, for removing charged particles from air.

The particle charging section 801 for the electrostatic charging of airborne soot particles in the airstream moved by the vehicle's air handling system comprises itself either photoelectric particle charging means using ultraviolet radiation or field/diffusion charging means wherein the air containing the airborne soot particles are exposed to a stream of positively or negatively charged small ions. Of course a combination of both means may also be used.

The filtering section 802, provided for removing at least part of the charged particles from the airstream moved by the vehicle's air handling system, comprises either an electret filter wherein a significant bipolar charge is permanently present on the polymeric fibers for capturing soot particles or an electrostatically-augmented filter embodied as a fibrous filter material sandwiched between two porous electrically conductive gauzes over which an electric potential is applied. Also, a parallel plate type filter may be used.

One embodiment for a soot sensor unit 21 in combination with an air cleaning system for removing soot particles, from the air moved by the vehicle's air handling system is shown in FIG. 11, in which the particle charging section 801 comprises extended (meandering) low-pressure UV light sources 81 (three in the present case) located upstream of the filtering section 802, which is, in the present case, an electrostatically-augmented fibrous filter 82. These UV light sources 81 irradiate all particles present in the airflow passing though the air handling unit with UV light comprising a wavelength below 260 nm, thereby imparting a photoelectrically-induced positive charge onto the soot particles. The magnitude of the created charge on the soot particles depends on the particle size and has a proportionality with the product of the illumination intensity of the UV light received by the particles and the residence time of the particles in the UV-illuminated region. The (meandering) tubular UV light sources 81 are shielded from direct exposure to the airflow by disposing an electrically conducting gauze 83 of high porosity around each UV source, which avoids a quick contamination of the outer surfaces of the UV light sources by depositing particles. The gauzes 83 are preferably earthed. The surfaces of the gauzes 83 are preferably covered with a thin coating of a non-metallic material in order to quench the photo-emission of electrons when said surfaces are irradiated with UV light emitted by the UV light sources 81.

The electrostatically-augmented filter 82 is embodied as a pleated fibrous filter sandwiched between two porous metal gauze electrodes 84a, 84b between which a voltage difference V_{filt} is established. The resulting electrostatic field across the thickness of this fibrous filter is now an externally-applied electric field which much enhances the filtration efficiency of the filter towards charged airborne particles while the incurred pressure drop across this filter can be maintained at a relatively low level. The electrostatically-augmented filter 82 removes the charged particles from air with an efficiency that increases with increasing particle charge, increasing electric field strength across the filter, and decreasing air speed through the filter. The high-voltage gauze 84a associated with the electrostatically-augmented filter 82 preferably faces the UV light sources 81 upstream of the filter. An electric field is thus created between the electrostatically-augmented filter 82 and the earthed gauzes 83 surrounding the UV light sources as well as between the electrostatically-augmented filter 82 and a second earthed gauze 85 of high porosity located upstream of the UV light sources 81. This electric field enhances the photoelectric charging of airborne soot particles since it enables a quick removal of photo-emitted electrons and negative small ions from air. Preferably, the high-voltage gauze 84a is connected to a high-voltage V_{filt} that is positive with respect to earth potential. This has the advantage that the electric field existing across the depth of the fibrous filter polarizes the filter fibers in such a way that it enhances the deposition of positively-charged particles on the upstream face of the polarized filter fibers. The gauze 84b is preferably earthed or connected to a potential that is negative with respect to earth potential.

The soot sensor 21 is located downstream of the electrostatically-augmented filter 82 and therefore senses only those soot particles that have been transmitted through said electrostatically-augmented filter.

In another embodiment, depicted in FIG. 12, a fibrous electret filter 92 is used for the capture of photoelectrically-charged soot particles and other charged particles, instead of the electrostatically-augmented one shown in FIG. 11. In this embodiment, similar to the embodiment described in said FIG. 11, the difference is that the electret filter is not sandwiched between two conductive porous gauze electrodes. An externally-applied electric field can therefore not be applied. Instead, localized electric fields exist inside the electret filter that are set up by the bipolar charge distribution on the fibers of the electret filter.

In still another embodiment, depicted in FIG. 13, the filter is a particle precipitation filter 100 comprising a set of stacked parallel plates or gauzes. Between these plates, connected alternately to earth potential (plates 101ₐ to 101ₙ₊₁) and to a high voltage V_{filt} (plates 101_{b} to 101ₙ), electrostatic fields are set up that promote the deposition of charged airborne particles onto the plate surfaces.

In another embodiment, depicted in FIG. 14, particle charging is accomplished through field/diffusion charging by exposing the air containing the airborne particles to a stream of unipolar ions 111 formed by a corona discharge from at least one needle-tip electrode 112 or from at least one thin-wire electrode (not shown) whereupon a high voltage V_{cor} is imposed, the stream of corona-emitted unipolar ions being emitted from the at least one needle tip electrode or thin-wire electrode towards the (preferably earthed) walls of at least one counterelectrode that is/are located in the proximity of the needle-tip electrode(s) or thin-wire electrode(s). Part of the counterelectrode surfaces may be formed by the inner wall of the duct through which the air is moved by the vehicle's air handling unit. Preferably, at least one insulating dielectric element 1013 is positioned in between the needle-tip electrode 112 and the gauze 85 (in FIG. 15) or in between the needle-tip electrode 112 and the filter 82 (in FIG. 14), the insulating element being positioned such that it partly obstructs the uninhibited passage of the airflow from the needle-tip electrode towards the filter downstream of the needle-tip electrode. The insulating dielectric element 1013 will quickly become charged through the emitted ions from the needle-tip electrode, thereby assuming a high electrostatic potential that induces a deflection of emitted ions from the needle-tip electrode towards the walls of the duct through which the air is moved by the vehicle's air handling unit, the said wall of the duct being preferably connected to earth potential, thus ensuring substantially all emitted ions to cross the flow lines of the airstream. The capture of charged particles occurs downstream of the needle-tip electrode 112 or thin-wire electrode by means of an electrostatically-augmented filter 82. Preferably, a small amount of activated carbon is present inside the electrostatically-augmented filter 82 and/or on the surfaces of the gauze electrodes 84 for the purpose of cleaning the air from the ozone gas produced by the corona discharge and/or the UV radiation inside the particle charging section 801.

Alternatively, a separate activated carbon filter may be installed downstream of the needle-tip electrode 112 or thin-wire electrode, the activated carbon filter being preferably embodied as a corrugated filter featuring substantially straight flow channels for the moving air (not shown), in order to minimize the incurred pressure drop across the activated carbon filter, and wherein the internal walls of said flow channels comprise activated carbon material.

In another embodiment, depicted in FIG. 15, field/diffusion charging of all particles by means of a corona discharge from at least one needle-tip electrode 112 or from at least one thin-wire electrode (not shown) is used together with photoelectric charging of soot particles by means of UV-light sources 81, surrounded, as above, by earthed gauzes 83. Preferably, the corona discharge in this embodiment is made to emit positive unipolar ions so that the acquired positive field/diffusion charge on at least some of the UFPs, notably the soot particles, is further augmented by a positive photo-electric charge. As in the previous embodiment, activated carbon is preferably present either inside the electrostatically-augmented filter 82 and/or on the surfaces of the gauze electrodes 84 and/or in a separate activated carbon filter to clean the air from the ozone gas produced by the corona discharge.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. An air pollution sensor system (1) incorporated in an enclosure (E), said enclosure comprising an air handling system inside an air duct (2), said air duct enabling a communication between air inside said enclosure and air outside said enclosure, said air duct comprising an air inlet for receiving air and an air outlet for releasing handled air inside said enclosure, wherein said air pollution sensor system comprises at least one soot particle sensor (21) capable of sensing soot particles with a diameter in a range of approximately 5-500 nm inside said enclosure and providing a pollution information signal (P) in response to the sensing of said soot particles.

2. The air pollution sensor system (1) according to claim 1, wherein said air handling system further comprises an air cleaning unit (13) within said air duct (2), wherein said soot particle sensor (21) is arranged to sense said soot particles downstream of said air cleaning unit.

3. The air pollution sensor system (1) according to claim 1, wherein said soot particle sensor (21) is arranged within said enclosure and outside of said air duct.

4. The air pollution sensor system (1) according to claim 3, wherein said air pollution sensor system comprises at least a second soot particle sensor unit (21) capable of sensing said soot particles in the said handled air within the said air duct or immediately downstream from said outlet of said air duct.

5. The air pollution sensor system (1) according to claim 1, wherein said air handling system comprises an electrically controllable air cleaning unit (13), and said air pollution sensor system is capable of providing said pollution information signal (P) to said air cleaning unit for controlling said air cleaning unit.

6. The air pollution sensor system (1) according to claim 1, wherein said air handling system comprises a controllable pump or ventilator unit (11) capable of displacing air between said air inlet and said air outlet of said air duct (2) and said air pollution sensor system is capable of providing said pollution information signal (P) to said pump or ventilator unit for controlling said displacement of air.

7. The air pollution sensor system (1) according to claim 1, wherein said air handling system comprises an air cleaning unit (13) capable of at least partly removing airborne soot particles and wherein said soot particle sensor unit (21) is positioned downstream of said air cleaning unit, said air cleaning unit comprising:
(a) a charging section (801) capable of electrically charging at least part of said airborne soot particles passing through said air duct;
(b) a filtering section (802) positioned downstream of said charging section, capable of removing at least part of the airborne soot particles received from said charging section,
wherein said soot particle sensor (21) is arranged such that at least a small volume of the airflow received from said filtering section is received by said ultra fine particle sensor.

8. A sensor unit (21) installable in a system (1) according to claim 1, in which said sensor unit is provided for the sensing of airborne soot particles with a diameter in a range of approximately 5-500 nm, said sensor unit comprising:
(a) an inlet section (210) capable of receiving an input influx airflow with charged and uncharged airborne soot particles;
(b) an illumination section (201) capable of receiving said input influx airflow with soot particles and positively charging at least a portion of said soot particles with ultraviolet light, said ultraviolet light comprising radiation with a wavelength below 260 nm, and
(c) a soot particle precipitation section (202) capable of receiving said charged and uncharged airborne soot particles and performing an electrostatic particle precipitation or particle filtration step to capture at least part of said charged soot particles and delivering an output airflow that is at least partially denuded of said charged airborne soot particles.

9. The sensor unit (21) according to claim 8, wherein said electrodes (218,219;518,519) form a cylindrical-concentric soot particle precipitator or a parallel-plate soot particle precipitator.

10. The sensor unit (21) according to claim 8, wherein said soot particle precipitation section (202) comprises a second flow conduit (217) which passes through a fibrous dust filter (62) disposed in a Faraday cage (61), said Faraday cage being connected via a current meter (221) to earth potential.

11. The sensor unit (21) according to claim 8, wherein said illumination section (201) comprises a first flow conduit (214), located between an ultraviolet light source (213) and an inner wall (215) of a sensor housing of said sensor unit, and said soot particle precipitation section (202) comprises a second flow conduit (217) located between two electrode surfaces (218,219;518,519) arranged to provide a high electric field and wherein said sensor unit is capable of establishing a thermal chimney effect by positioning said sensor unit vertically with said second flow conduit substantially above the said first flow conduit.

12. An air handling system installable in a system (1) according to claim 1, with an air cleaning unit (13) comprising:
(a) a soot particle charging section (801) capable of electrically charging at least part of said soot particles;
(b) a filtering section (802) capable of removing at least part of said charged soot particles from the airflow thus obtained from said charging section.

13. The air handling system according to claim 12, wherein said soot particle charging section (801) comprises one or more ultraviolet light sources (81) located upstream of said filtering section (802), said ultraviolet light sources being capable of emitting radiation with a wavelength spectrum comprising a wavelength below 260 nm.

14. The air handling system according to claim 13, wherein said soot particle charging section (801) further comprises at least one thin-wire electrode or needle-tip electrode (112) at high voltage capable of exposing said airflow passing through said air duct to a stream of charged unipolar ions formed by a corona discharge from said thin-wire electrode or from said needle-tip electrode.

15. The air handling system according to claim 12, wherein said filtering section (802) comprises activated carbon capable of cleaning said airflow from ozone gas.

16. The air handling system according to claim 12, wherein said filtering section (802) comprises an electrostatically augmented particle filter (82) located downstream of said soot particle charging section.

17. The air handling system according to claim 16, wherein said electrostatically augmented particle filter is a pleated electrically non-conductive fibrous filter sandwiched between two electrically conductive porous layers (84a,84b) between which a voltage difference can be established, thereby creating an externally-applied electric field across said electrically non-conductive fibrous filter.

18. The air handling system according to claim 17, wherein the electrically conductive porous layer facing said charging section is connected to a high voltage potential (V_{filt} ) and in which the electrically conductive gauze electrode facing away from said charging section is connected to earth potential.

19. The air handling system according to claim 12, wherein said electrostatically augmented particle filter (82) is a fibrous electret filter.

20. The air handling system according to claim 16, wherein said electrostatically augmented particle filter is a parallel-plate type precipitation filter (100), the air handling system being arranged such that alternate plates of said precipitation filter are connected to a high voltage potential V_{filt} and earth potential.
